(19) United States
(12) Patent Application Publication
(10) Pub. No.: US 2015/0109934 A1
(43) Pub. Date: Apr. 23, 2015

(54) INTERNET PROTOCOL ROUTING MEHTOD AND ASSOCIATED ARCHITECTURES

(71) Applicant: Paramasiviah HARSHAVARDHA, MARLBORO, NJ (US)

(72) Inventor: Paramasiviah HARSHAVARDHA, MARLBORO, NJ (US)

(21) Appl. No.: 14/521,155

(22) Filed: Oct. 22, 2014

Related U.S. Application Data
(60) Provisional application No. 61/894,689, filed on Oct. 23, 2013.

(51) Int. Cl. H04L 12/729; H04L 12/24; H04L 12/801

(52) U.S. Cl. CPC H04L 45/125; H04L 47/12; H04L 41/5019
USPC 370/238

(57) ABSTRACT

Disclosed are structures and methods for improved routing methods for IP networks that advantageously extend the IP shortest path routing capability by establishing pre-computed longer paths that can be activated on-demand to alleviate network link congestion caused by the heavy data loads. These pre-computed longer paths allow an IP network to more effectively meet an application's stringent performance SLA while at the same time supporting large bandwidths to carry large volumes of data. In further sharp contrast to the shortest path methodologies, methods according to the present invention find longer paths—where they exist—to avoid congested links along the shortest path. Of further advantage, methods according to the present disclosure guarantee that no loops are formed when the longer paths are chosen. Significantly methods according to the present disclosure work with all data networks employing shortest path routing. Examples of network routing protocols that work with methods according to the present disclosure include those associated with IP networks—RIP (Routing Information Protocol), IGRP (interior Gateway Routing Protocol), OSPF (Open Shortest Path First), IS-IS (Intermediate System to Intermediate System), and Ethernet networks—STP (Spanning Tree Protocol), TRILL (Transparent Interconnect of Lots of Links), BGP (Border Gateway Protocol) and IEEE 802.1.aq SPB (Shortest Path Bridging).

### CROSS REFERENCE TO RELATED APPLICATIONS

This application claims the benefit of U.S. Provisional Patent Application Ser. No. 61/894,689 filed Oct. 23, 2013 which is incorporated by reference in its entirety as if set forth at length herein.

### TECHNICAL FIELD

This disclosure relates generally to internetworking and more particularly to a routing method for networks employing an Internet Protocol (IP) and associated network architecture(s) supporting the methods.

### BACKGROUND

As will be readily appreciated by those skilled in the art, IP networks have grown in size, complexity, reach and importance due—in part—to their widespread adoption as the networking paradigm of choice for both enterprise and other wide area networks. Contributing to that importance is the more recent utilization of “cloud computing” and big data analytics which have further established the criticality of IP networking with respect to data center operations. Given its importance, improved IP routing methods would represent a welcome addition to the art.

### SUMMARY

An advance in the art is made according to an aspect of the present disclosure directed to improved routing methods for IP networks and associated network architecture(s) supporting these improved methods.

In sharp contrast to prior art methods that continue to perpetuate a lack of flexibility exhibited by the shortest path routing mechanism employed within IP networks, method(s) according to the present disclosure advantageously extend the IP shortest path routing capability by establishing pre-computed longer paths that can be activated on-demand to alleviate network link congestion caused by the heavy data loads. These pre-computed longer paths allow an IP network to more effectively meet an application's stringent performance SLA while at the same time supporting large bandwidths to carry large volumes of data.

In further sharp contrast to contemporary shortest path methodologies, methods according to the present invention find longer paths—where they exist—to avoid congested links along the shortest path. Of further advantage, methods according to the present disclosure guarantee that no loops are formed when the longer paths are chosen. As may be immediately appreciated by those skilled in the art, such a no loop guarantee is of vital importance as the existence of loops will cause wasted network resources and may even lead to network failures

Significantly, methods according to the present disclosure work with all data networks employing shortest path routing. Examples of network routing protocols that work with methods according to the present disclosure include those associated with IP networks—RIP (Routing Information Protocol), IGRP (interior Gateway Routing Protocol), OSPF (Open Shortest Path First), IS-IS (Intermediate System to Intermediate System), and Ethernet networks—STP (Spanning Tree Protocol), TRILL (Transparent Interconnect of Lots of Links) and IEEE 802.1.aq SPB (Shortest Path Bridging).

### BRIEF DESCRIPTION OF THE DRAWING

A more complete understanding of the present disclosure may be realized by reference to the accompanying drawing in which:

FIG. 1 shows a schematic of an illustrative Leaf-Spine Clos network;

FIG. 2 shows a schematic of an illustrative Leaf-Spine modified Clos network;

FIG. 3 shows a schematic of an illustrative shortest path routed network that is routed at router A;

FIG. 4 shows a schematic of an illustrative shortest path routed network that is routed at router D;

FIG. 5 shows a schematic of an illustrative shortest path routed network according to an aspect of the present disclosure;

FIGS. 6(a) and 6(b) shows a schematic flow chart of a routing method according to an aspect of the present disclosure;

FIG. 7 shows a schematic flow chart of a routing method according to an aspect of the present disclosure;

FIG. 8 shows a block diagram depicting a shortest path constructed according to an aspect of the present disclosure; and

FIG. 9 shows a block diagram depicting an illustrative computer system according to an aspect of the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not be shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, we begin by noting that contemporary “webscale” data centers may include hundreds of thousands of servers hosting a multitude of web based applications requiring very high quality network performance meeting stringent Service Level Agreement (SLA) criteria. Such SLA criteria may include—for example—low latency, low packet loss and satisfactory retransmission characteristics.

At the same time, application data volume has increased by several orders of magnitude, promoted in part by recent developments such as Hadoop [See, e.g., White, T., “Hadoop The Definitive Guide,” O'Reilly Media Inc., 2009] which make possible the distributed processing of petabytes of data within a reasonable amount of time—e.g., a few hours.

As may be immediately appreciated, these requirements of large bandwidth and strict SLA performance significantly stress the capabilities of contemporary IP networks which oftentimes exhibit difficulty in meeting these requirements. One reason for this difficulty is that a shortest path routing mechanism generally employed within IP networks lacks flexibility. As previously noted—and in sharp contrast to such shortest path routing—an aspect of the present disclosure is directed to a method whereby pre-computed longer paths are established and activated on-demand such that network link congestion is alleviated while an application's stringent SLA performance and large bandwidth requirements are met.

For our purposes herein, we assume that networks under consideration are IP networks employing open shortest path first (OSPF). As those skilled in the art will readily know and appreciate, OSPF is a routing protocol used in IP networks that uses a link state routing algorithm. It is among the most widely used interior gateway protocols in enterprise networks.

OSPF is an interior gateway protocol (IGP) for routing Internet Protocol (IP) packets solely within a single routing domain, such as an autonomous system. It gathers link state information from available routers and constructs a topology map of the network. The topology is presented as a routing table to the Internet Layer which routes datagrams based on a destination IP address found in IP packets. OSPF supports Internet Protocol Version 4 (IPv4) and Internet Protocol Version 6 (IPv6) networks and features variable-length subnet masking (VLSM) and Classless Inter-Domain Routing (CIDR) addressing models.

Operationally, OSPF detects changes in the topology, such as link failures, and converges on a new loop-free routing structure within seconds. It computes the shortest path tree for each route using a method based on Dijkstra's algorithm, a shortest path first algorithm. The OSPF routing policies for constructing a route table are governed by link cost factors (external metrics) associated with each routing interface. Cost factors may be the distance of a router (round-trip time), data throughput of a link, or link availability and reliability, expressed as simple unitless numbers. This provides a dynamic process of traffic load balancing between routes of equal cost.

An OSPF network may be structured, or subdivided, into routing areas to simplify administration and optimize traffic and resource utilization. Areas are identified by 32-bit numbers, expressed either simply in decimal, or often in octet-based dot-decimal notation, familiar from IPv4 address notation.

By convention, area 0 (zero), or 0.0.0.0, represents the core or backbone area of an OSPF network. The identifications of other areas may be chosen at will; often, administrators select the IP address of a main router in an area as area identification. Each additional area must have a direct or virtual connection to the OSPF backbone area. Such connections are maintained by an interconnecting router, known as area border router (ABR). An ABR maintains separate link state databases for each area it serves and maintains summarized routes for all areas in the network.

OSPF does not use a TCP/IP transport protocol, such as UDP or TCP, but encapsulates its data in IP datagrams with protocol number 89. This is in contrast to other routing protocols, such as the Routing Information Protocol (RIP) and the Border Gateway Protocol (BGP). OSPF implements its own error detection and correction functions.

OSPF uses multicast addressing for route flooding on a broadcast domain. For non-broadcast networks, special provisions for configuration facilitate neighbor discovery. OSPF multicast IP packets never traverse IP routers (never traverse Broadcast Domains), they never travel more than one hop. OSPF is therefore a Link Layer protocol in the Internet Protocol Suite. OSPF reserves the multicast addresses 224.0.0.5 (IPv4) and FF02::5 (IPv6) for all SPF/link state routers (AllSPFRouters) and 224.0.0.6 (IPv4) and FF02::6 (IPv6) for all Designated Routers (AllDRouters), as specified in RFC 2328 and RFC 5340.

For routing multicast IP traffic, OSPF supports the Multicast Open Shortest Path First protocol (MOSPF) as defined in RFC 1584. PIM (Protocol Independent Multicast) in conjunction with OSPF or other IGPs, is widely deployed.

The OSPF protocol, when running on IPv4, can operate securely between routers, optionally using a variety of authentication methods to allow only trusted routers to participate in routing. OSPFv3, running on IPv6, no longer supports protocol-internal authentication. Instead, it relies on IPv6 protocol security (IPsec).

OSPF version 3 introduces modifications to the IPv4 implementation of the protocol. Except for virtual links, all neighbor exchanges use IPv6 link-local addressing exclusively. The IPv6 protocol runs per link, rather than based on the subnet. All IP prefix information has been removed from the link-state advertisements and from the Hello discovery packet making OSPFv3 essentially protocol-independent. Despite the expanded IP addressing to 128-bits in IPv6, area and router Identifications are still based on 32-bit values.

With this general description of OSPF in place, we now provide a brief description of IP network operation using OSPF. For our purposes, we are mainly concerned with three types of IP network entities namely, servers, routers and access networks, the latter of which is commonly known in IP parlance as networks.

Servers, routers and networks each have IP addresses. An example IP address in decimal notation is 100.101.1.1. Servers generate IP packets containing the IP address of the destination server to which the packet is to be delivered. Routers forward these packets to the destination network specified by the destination network address contained in the IP packet, by employing shortest path routing (there are some exceptions to this, such as explicit routing which allows any end-end path to be specified for a given source-destination pair, but shortest path routing is by far the primary routing mechanism employed by IP networks).

In order to construct shortest path routes to each destination network address, OSPF uses LSAs (Link State Advertisements) to build an LSDB (Link State Database). LSAs are messages generated by routers containing information about the servers, routers and networks they are connected to. These messages are “flooded” to the entire network thereby allowing every router in the network to generate a view of the entire network topology, which is captured in its LSDB. Using its LSDB, the router builds a Shortest Path Tree (SPT) with itself as the root which it uses to generate shortest paths to every destination network.

Within the IP network routers recognize one or more IP flows that can be defined by one or more parameters including the destination IP address. In addition to the destination IP address, other parameters such as source IP address, source port number, destination port number, the type of higher layer protocol encapsulated within the IP packet (for e.g., TCP or UDP), may be used for defining an IP flow. Routers store the computed shortest paths for each destination in a routing table. Optionally, routers may also employ a flow table which lists shortest path routes for a subset of defined flows. This mechanism is used to provide finer granularity in making routing choices within the network. When an IP packet enters a router, the router decides how to forward the packet by looking up the routing table or, if present, the flow table.

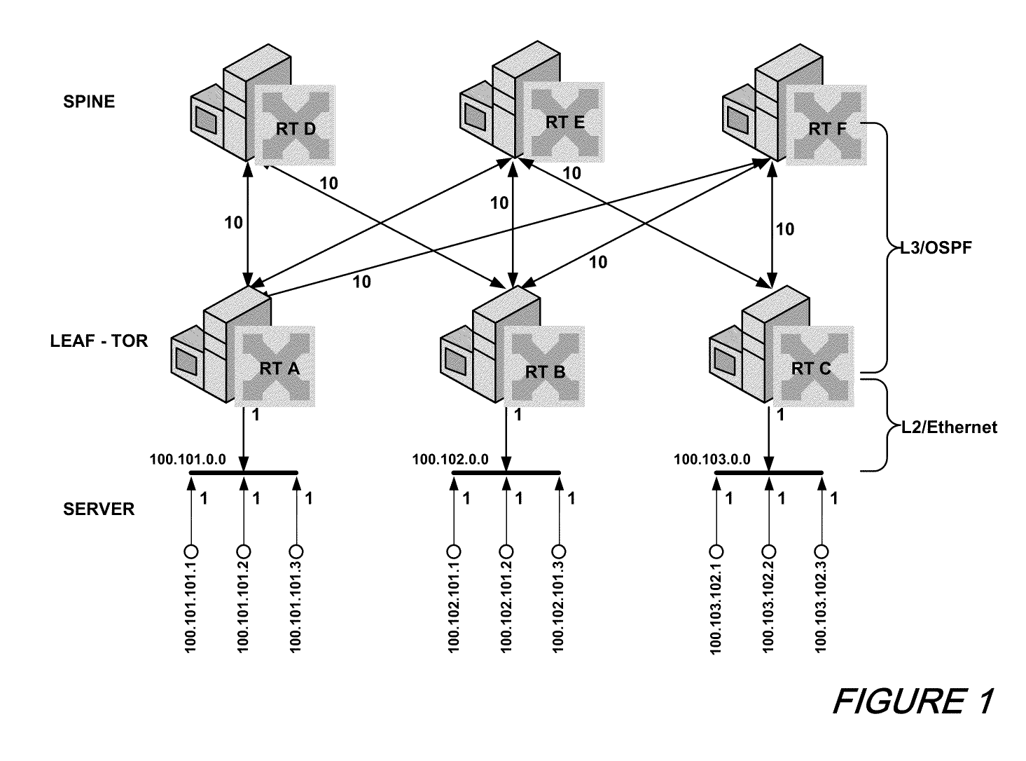

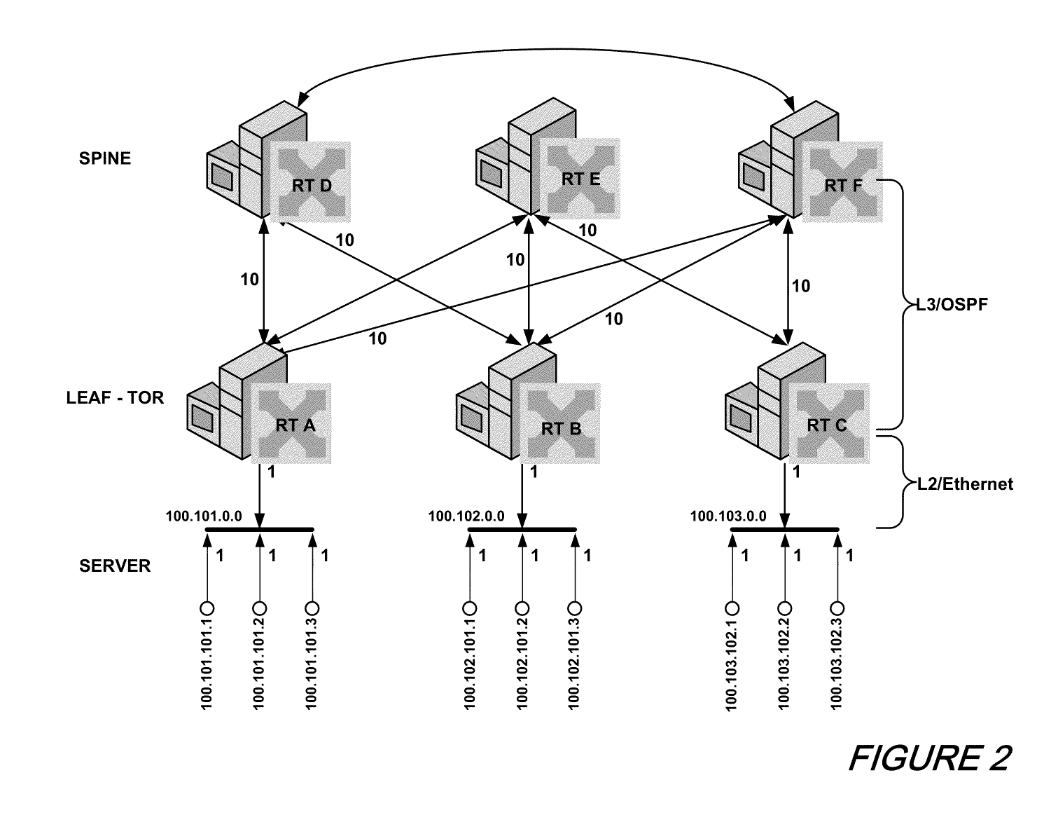

FIG. 1 shows a schematic of an illustrative Leaf-Spine Clos network while FIG. 2 shows a schematic of an illustrative Leaf-Spine modified Clos network. We now describe methods according to the present disclosure with reference to the IP network depicted schematically in FIG. 2.

With initial reference to FIG. 1, there it may be observed that lower layer routers namely, RT A, RT B and RT C, are Top Of Rack (TOR) routers and are known as the leaf nodes. Higher layer routers namely, RT D, RT E and RT F are known as spine nodes. As may be readily understood and appreciated, the Clos network depicted in FIG. 1 connects every leaf node to every spine node and achieves a non-blocking architecture. Architectures such as that depicted in FIG. 1 are becoming increasingly popular for datacenter IP networks.

With reference now to FIG. 2, there is shown a modified Clos network wherein the modification includes links interconnecting spine nodes. As will be discussed, such modification is employed according to the present disclosure as it advantageously permits alternate routing at the spine nodes.

As may be observed, FIG. 2 shows a network comprising 6 routers namely, RT A, RT B, RT C, RT D, RT E and RT F, and 3 access networks. Each access network is an Ethernet network that connects 3 attached servers to an IP router. The IP network is a Layer 3 (L3) network while the Ethernet network is a Layer 2 (L2) network. As is common, the entire network is referred to as an IP network.

The IP addresses of the three access networks shown in the figure are 100.101.0.0, 100.102.0.0 and 100.103.0.0. The IP addresses of the attached servers are also shown in the figure. Typically, any routers within the network are also assigned IP addresses, but they are not shown in this figure as they are not needed for describing a method according to the present disclosure.

As previously noted, we assume that the IP network is running the OSPF protocol. The OSPF protocol assigns each router a unique 32-bit ID. IP routers forward packets based on longest prefix matching of the packet's IP address with IP addresses stored within the router's routing table.

For example, packets generated by server 100.101.101.1, destined for server 100.102.102.1, may be forwarded by router RT A, based on the destination network address which is 100.102.0.0. This mechanism is employed to keep the size of the routing table manageable.

FIG. 2 shows the “cost” of each link (next to each link) within the network. As depicted therein, all links from routers and servers to access networks have been assigned a cost of 1, while all links connecting two routers are assigned a cost of 10. Typically, the link cost is proportional to the bandwidth of the link.

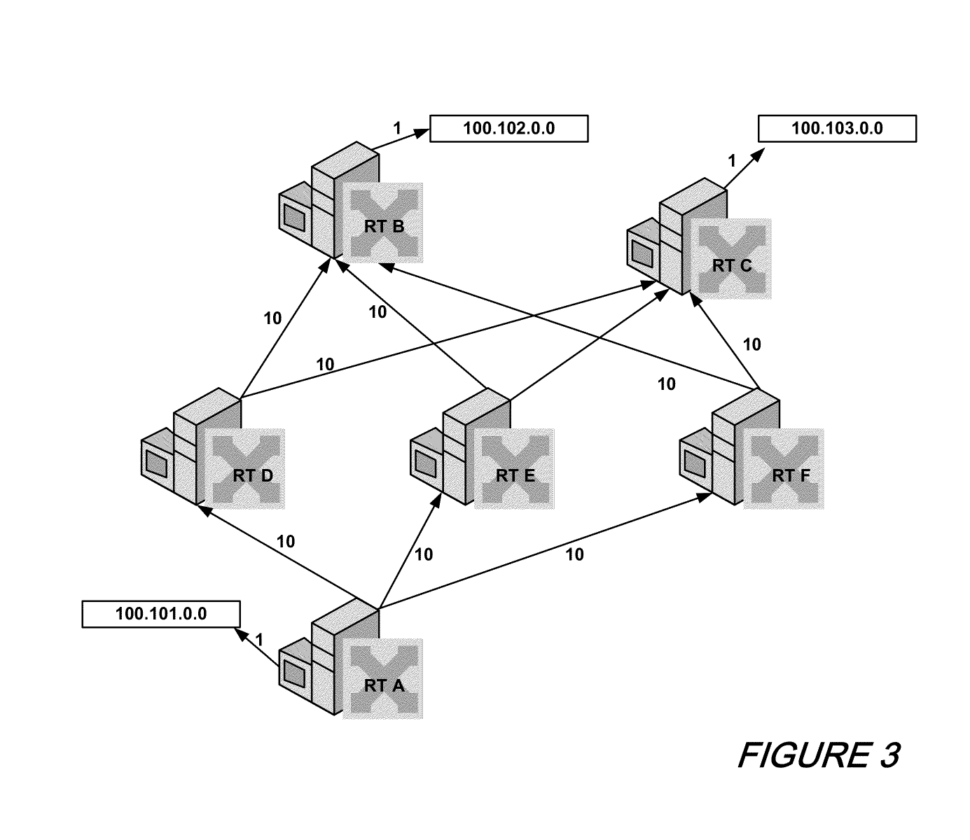

In order to forward packets to their intended destinations, each router constructs a Shortest Path Tree (SPT) with itself as the root. Link costs are used by the routers to compute the shortest path routes to various destinations. FIG. 3 shows the SPT at router RT A.

As may be observed by inspection of FIG. 3 that for destination network 100.102.0.0, there are three shortest paths from RT A each having a total cost of 21. The three paths are: RT A->RT D->RT B->100.102.0.0, RT A->RT E->RT B->100.102.0.0 and RT A->RT F->RT B->100.102.0.0. These paths are known as ECMP (Equal Cost Multi Path) paths.

Router RT A may be configured to use all three ECMP paths for forwarding packets to destination 100.102.0.0. This may be done by splitting IP flows between the three paths according to some criterion for example by cycling among the paths using an ECMP hash algorithm. As may be readily appreciated, there exists only one shortest path from RT A to the directly attached network 100.101.0.0. These are examples of typical shortest paths computed by IP routers using the current state-of-the-art methodologies.

As will be described in detail and in sharp contrast to the shortest path methodologies, methods according to the present invention find longer paths—where they exist—to avoid congested links along the shortest path. Of further advantage, methods according to the present disclosure guarantee that no loops are formed when the longer paths are chosen. As may be immediately appreciated by those skilled in the art, such an no loop guarantee is of vital importance as the existence of loops will cause wasted network resources and may even lead to network failures.

Those skilled in the art will appreciate that congestion avoidance is very important in large IP networks such as webscale data center networks. This is because, in such networks, the traffic volume associated with a specific IP flow can vary drastically over time. For example, studies in data center networks have shown that at a given time about 15% of the links within the data center are congested. Furthermore, the congestion location within the network keeps changing and different links may be congested at different times. Such link congestion may last from a few tens of milliseconds to a few hundred seconds. Advantageously, the longer paths identified according to the present disclosure deload links experiencing significant congestion lasting from a few hundred milliseconds to a few hundred seconds.

### Computing Longer Paths to Deload Links

We may now illustrate such congestion avoidance mechanism according to the present disclosure with further reference to the illustrative network shown in FIG. 2. To simplify our discussion we focus our attention on IP flows from router RT A to destination network 100.102.0.0. As should be appreciated, while our discussion is limited our inventive principles according to the present disclosure are not so limited and—as such—methods according to the present disclosure advantageously are applicable to all IP flows within the network between any pair of access networks, or any access network and router pair.

As shown in FIG. 3, RT A has three shortest paths to destination network 100.102.0.0: RT A->RT D->RT B->100.102.0.0, RT A->RT E->RT B->100.102.0.0 and RT A->RT F->RT B->100.102.0.0. In leaf-spine networks such as the one shown in FIG. 2, the uplinks are not very likely to be congested.

For example, the uplink from RT A->RT D only carries traffic from network 100.101.0.0 and can always be engineered to avoid becoming congested by restricting oversubscription of its bandwidth, typically by a factor of 2 to 3. Thus, for example, if the interface from network 100.101.0.0 has a bandwidth of 50 Gbps, then by providing 2, 10 Gbps uplinks from RT A to RT D and RT E in the spine network, we achieve an oversubscription ratio of 2.5:1. Of course, more uplinks can be added to reduce the oversubscription ratio if needed. The over subscription ratio thus provides an engineering parameter for avoiding uplink congestion.

Downlinks, however, can carry traffic from multiple networks to a single destination network. For example, the downlink from RT E->RT B can carry traffic from networks 100.101.0.0 and 100.103.0.0 to destination network 100.102.0.0. Such down links experience greater unpredictability in their traffic patterns and are more likely to experience congestion. They are, therefore, in greater need of a congestion avoidance mechanism. Advantageously, methods according to the present disclosure find longer paths to avoid congestion on any link whenever the network topology makes it possible. Accordingly—as should be apparent to those skilled in the art—downlinks are more likely to experience congestion than uplinks in typical IP networks.

In accordance to the present disclosure, the downlinks in the three shortest paths, viz., RT D->RT B, RTE->RTB, and RT F->RT B, can all be deloaded by moving traffic to longer paths while guaranteeing that no loops are formed. Should any of these downlinks become congested, traffic can be directed to the corresponding longer path, so as to mitigate the congestion condition.

We will now proceed to illustrate how this is achieved. It should again be emphasized that while our methods according to the present disclosure find longer paths to deload links wherever they exist, we describe downlinks—for the purpose of illustration—as they typically experience more congestion.

For example, by adding an extra link from router RT A to RT B in the network depicted in FIG. 2, we change (modify) the network topology thereby allowing longer paths to the uplink RT A->RT B. For this modified topology our methods would find longer paths to deload the uplink RT A->RT B.

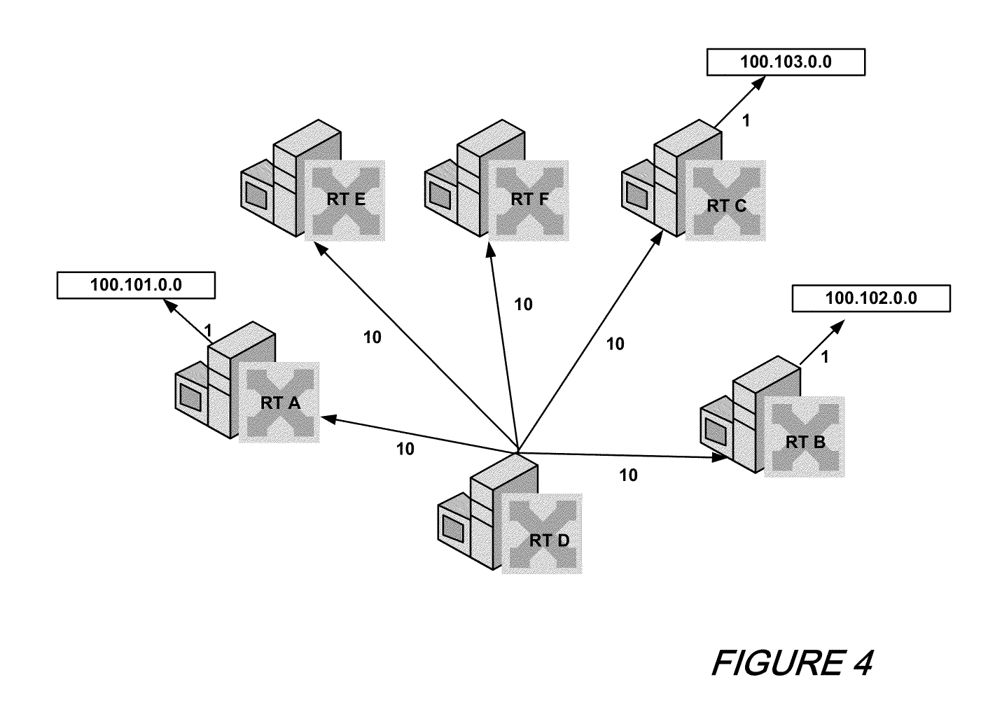

Returning to the illustrative network of FIG. 2, in order to avoid the downlink RT D->RT B for traffic to destination network 100.102.0.0, router RT D must find a longer path that bypasses the link RT D->RT B for traffic to destination network 100.102.0.0. To demonstrate how methods according to the present disclosure achieve this result, consider FIG. 4 which depicts the SPT rooted at RT D.

With reference to FIG. 4 it may be observed that neighboring routers of RT D are RT A, RT E and RT F, in addition to RT B and RT C. Since RT D already uses RT B as shortest path neighbor, it cannot be considered for the longer alternate path. RT D must, therefore, determine to which of its neighbors, RT A, RT C, RT E or RT F, it can forward traffic destined to 100.102.0.0, if the shortest path link RT D->RT B becomes congested. According to an aspect of the present disclosure, RT D makes this determination by means of the following steps.

Step 1: By examining its Link State Database (LSDB), RT D computes the shortest path cost from each of the neighbors RT A, RT C, RT E and RT F to destination network 100.102.0.0. The shortest path cost from RT A to 100.102.0.0 is 21, from RT C to 100.102.0.0 is 21, from RT E to 100.102.0.0 is 11 and from RT F to 100.102.0.0 is 11.

As may be readily appreciated, there are several choices of methods for performing the necessary computations to determine the shortest path costs. One simple method is to keep track of the costs of all the paths from RT D to the destination network 100.102.0.0 encountered in constructing the SPT shown in FIG. 3. Alternatively, RT D may construct SPTs rooted at RT A, RT C, RT E and RT F to determine the shortest path costs from RT A, RT C, RT E and RT F to network 100.102.0.0. Advantageously, these techniques are readily available to anyone conversant with the state of the art in IP networks employing OSPF.

RT D's shortest path cost to 100.102.0.0 is also 11. RT D discards RT A as a candidate next hop router on the longer path to destination 100.102.0.0, as the shortest path cost from RT A is more than the shortest path cost from RT D. For the same reason, RT C is also discarded.

The generalization of Step 1 to an arbitrary IP network may be described as follows: discard all candidate routers whose shortest path cost to the destination access network is greater than the shortest path cost of the current router to that destination network. Among neighbors with shortest path cost less than that of the current router, discard those neighbors that are on ECMP paths from the current router. There may be only one shortest path from the current router to that destination network in which case that is the unique shortest path (and, thus, there are no ECMP paths available). In this case, discard the neighbor on the unique shortest path. If ECMP paths do exist, then for a specific flow, as an option, only the neighbor router on the ECMP path assigned for that flow may be discarded; this will allow other ECMP paths to be used by the flow in the event of congestion. In general, it is not preferable to use a neighbor on an ECMP path for congestion deloading, as routers already use ECMP paths for load balancing.

If there is a neighbor with shortest path cost less than that of the current router, and the neighbor is not on any of the ECMP paths of the current router, then pick that neighbor as the next hop router on the longer path. If there is more than one such neighbor router, then pick the neighbor router with the lowest cost to destination D as the next hop router on the longer path. If no valid neighbor router is found in Step 1, proceed to Step 2.

Step 2: At this point, only candidate neighbor routers with shortest path cost equal to the shortest path cost of the current router are left for consideration. We refer to such neighbors as equal cost neighbor routers. For RT D shown in FIG. 3, RT E and RT F are the equal cost candidate neighbor routers. To determine which of RT E or RT F to select as the next hop router on the longer path to destination 100.102.0.0, methods according to the present disclosure use the 32 bit OSPF IDs of the routers (if other routing protocols are used, then the unique ID assigned to the router by the protocol can be used in place of the OSPF ID). In place of the OSPF ID, any other unique ID assigned to the router, for example, management IP addresses assigned to a router, may also be used.

For illustration, let us assume that the decimal value of the OSPF ID of RT D is 10, of RT E is 7 and of RT F is 8. RT D simply picks the router with the lowest numerical OSPF ID value as the next hop router. In the current illustration, RT E has the lowest OSPF ID value of 7 so RT D picks RT E as the next hop router on the longer path (one can also pick the router with the highest numerical OSPF ID value; picking the highest value at every router, or the lowest value at every router, will both work as long as the rule is consistently applied at all routers).

It is quite possible—depending on the network topology—that a given router has no equal cost candidate neighbor routers. In that case, no alternate routing is possible at such a router and no link deloading to avoid congestion can be done. The procedure should, however, continue with other routers and find alternate routing interfaces wherever possible. This is never the case for spine nodes in the modified Clos network as every spine node will have at least one equal cost candidate neighbor router.

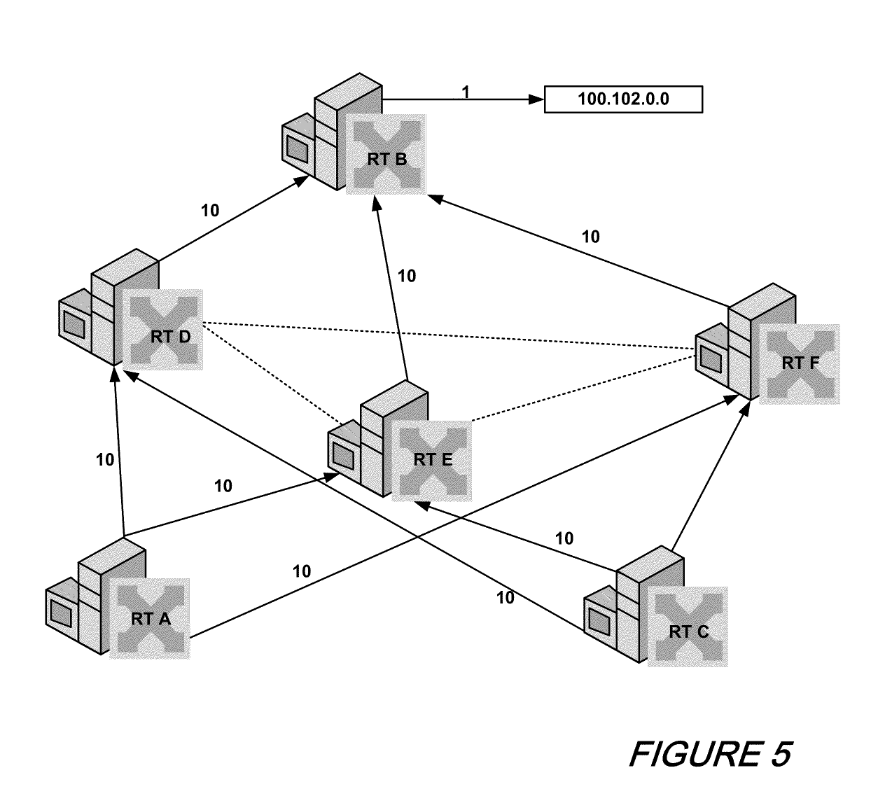

In order to show that the above procedure is guaranteed to avoid loops, consider FIG. 5. FIG. 5 shows the shortest path from each router to destination network 100.102.0.0, along with links interconnecting routers RT D, RT E and RT F (in dotted line). The link cost for each link in the shortest path to destination 100.102.0.0 is also shown.

In Step 2 above we noted that RT D picks RT E as the next hop neighbor on the longer path to 100.102.0.0. Applying Step 1 to RT E, and RT F shows that no viable neighbor router exists. Applying Step 2 to RT E, it is clear that RT D and RT F are the equal cost candidate neighbors of RT E available to serve as the next hop router on the longer path to deload link RT E->RT B for traffic to destination 100.102.0.0.

Similarly, for RT F, applying Step 2 yields RT D and RT E as the candidate next hop routers on the longer path to deload link RT F->RT B for traffic to destination 100.102.0.0. Applying Step 2 at RT E we find that RT F has the lowest OSPF ID value of 8 so RT E picks RT F as the next hop neighbor on its longer path to destination 100.102.0.0.

Applying Step 2 at RT F we find that RT E has a lower OSPF ID value than RT D, so RT F picks RT E as the next hop neighbor on its longer path to destination 100.102.0.0. Consequently, a loop comprising RT D->RT E->RT F->RT D cannot be formed. It should be noted, however, that a single-link loop between RT E and RT F is formed. Such a single-link loop is an unavoidable graph theoretic constraint. In practice, this is not a problem as router RT F knows when a packet for destination 100.102.0.0 is sent to it by router RT E and can easily prevent it from being sent back to router RT E. Advantageously methods according to the present disclosure exploit this knowledge to explicitly prevent single-link loops.

The generalization of Step 2 to an arbitrary network is as follows: each router picks the equal cost candidate neighbor with the lowest ID value to serve as next hop on its longer path to the destination network under consideration. This procedure guarantees that no loop can form. A single-link loop will always occur, but packet looping can be prevented by the routers at the two ends of the link.

It can be easily shown in the general case that within any set of candidate neighbor routers, applying the above two step process always leads to a strict descending hierarchy by virtue of: a) picking only neighbors with shortest path cost to a specific destination that is not greater than the shortest path cost from the current router as candidate routers, and, b) using the minimum ID value criterion to choose among the candidate neighbors (see proof later in this disclosure). Because of the strict descending hierarchy, once the very last router is reached a single-link loop will be formed; thus a non-single-link loop can never be formed. It is possible to relax the choice of candidate routers to include neighbor routers with shortest path cost greater than the current router's shortest path cost, provided its shortest path cost is within certain bounds. For simplicity we omit that case here.

Methods according to the present disclosure systematically applies the above two steps at every router in the IP network, for each destination network address, to pre-compute all possible longer paths supported by the IP network topology. In accordance with our methods, these pre-computed longer paths will then be used to deload specific links when they experience congestion.

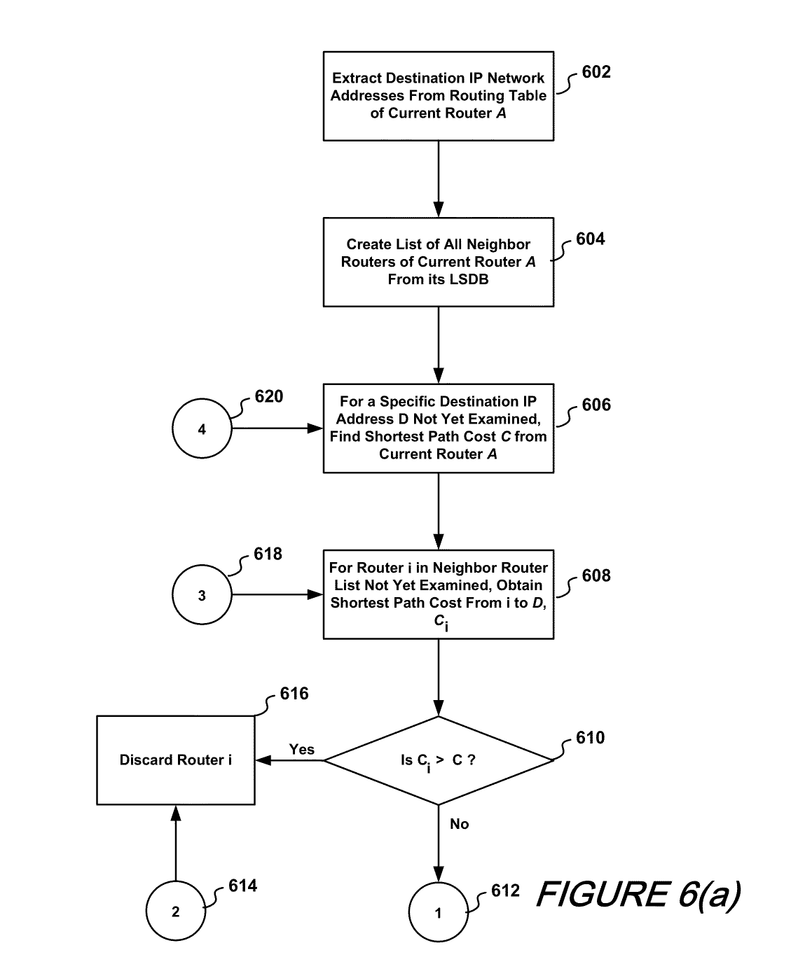

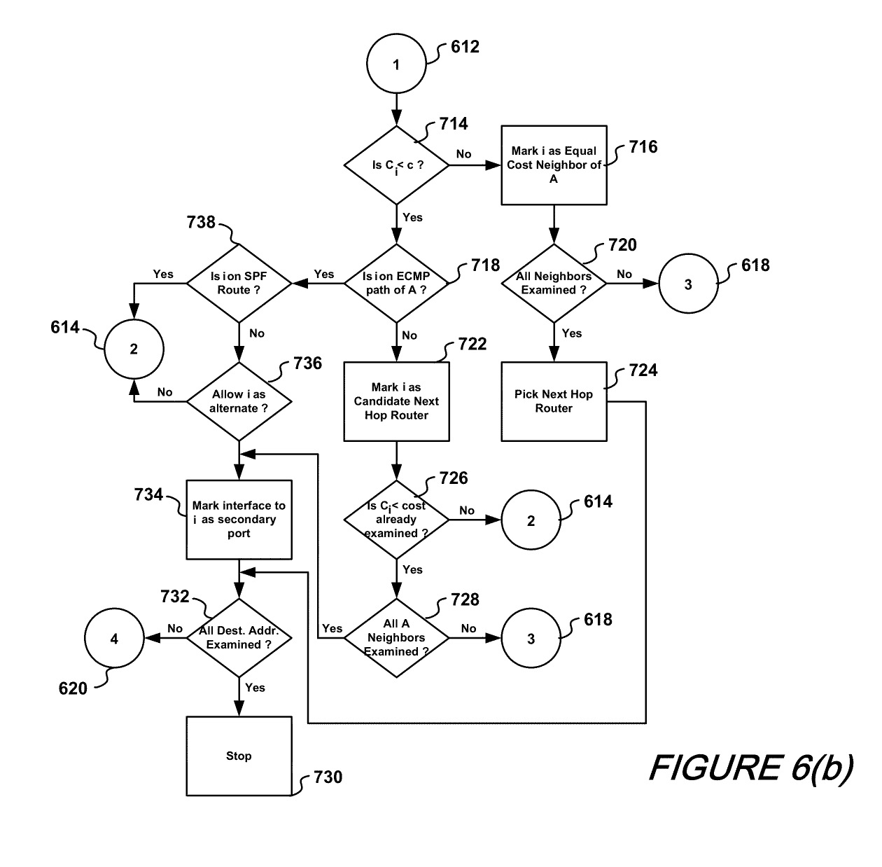

At this point we may review an overall method according to the present disclosure as depicted schematically in a flow chart shown in FIGS. 6(a) and 6(b). With simultaneous reference to those figures, we note in FIG. 6(a) at block 602 that for a current router A, destination IP network addresses are extracted from the routing table of that router A. From there, at block 604, a list of all neighbor routers of router A is created from its LSDB.

At block 606, for a specific destination IP address D—not yet examined—the shortest path cost C from current router A is determined. At block 608, for router i in neighbor router list not examined, the shortest path cost from i to D is obtained. That shortest path cost from i to D is called Cᵢ.

Next, at block 610, a determination is made whether or not Cᵢ is greater than C. If so then Router i is discarded from consideration. If not, then control is directed to off-page reference 1, which is on FIG. 6(b).

With reference to FIG. 6(b) we may further follow the steps associated with a method according to the present disclosure. At block 714, a determination is made whether or not Cᵢ is less than C. If not, then i is marked as an equal cost neighbor of A at block 716.

At block 720, a determination is made whether or not all neighbor routers are examined. If not, then control is directed off-page to 618 which is shown in FIG. 6(a). If all neighbors have been examined, then at block 724 an equal cost neighbor k with lowest OSPF id value is chosen as the next hop router for D and an interface on A to k is marked as a secondary port for D. Control is then directed to block 732.

At that block 732 a determination is made whether or not all destination addresses at A have been examined. If they have then the process is stopped at block 730, else control is directed to block 620 of FIG. 6(a).

Returning to our discussion of block 714 wherein a determination is made whether or not Cᵢ is less than C. If Cᵢ is found to be less than C, then a determination is made at block 718 whether or not i is on ECMP path of A. If not, then at block 722 i is marked as a candidate next hop router.

At block 726 a determination is made whether or not Cᵢ is less than the cost of already examined candidate routers for D. If not, then control is directed to block 614 of FIG. 6(a). If it has already been examined, then at block 728 a determination is made whether or not all neighbors of A have been examined. If not, then control is directed to block 618 of FIG. 6(a). If they have all been examined, then control is directed to block 734.

At block 734, an interface to i on router A is marked as a secondary port for destination D. Control then proceeds to block 732, where a determination is made whether or not all destination addresses at A have been examined. If so, then the process stops at block 730. If not, then control is directed to block 620 of FIG. 6(a).

Returning to our discussion of the determination made at block 718, wherein a determination was made whether or not i is on ECMP path of A. If it is on that path, then control is directed to block 738 wherein a determination is made whether or not i is on Shortest Path First (SPF) route for D at A. If so, then control is directed to block 614 of FIG. 6(a), else control is directed to block 736 where a determination is made to allow ECMP neighbor i as alternate router. If allowed, then control is directed to block 614 of FIG. 6(a), else control is directed to block 734.

### Congestion Avoidance Using Pre-Computed Longer Paths

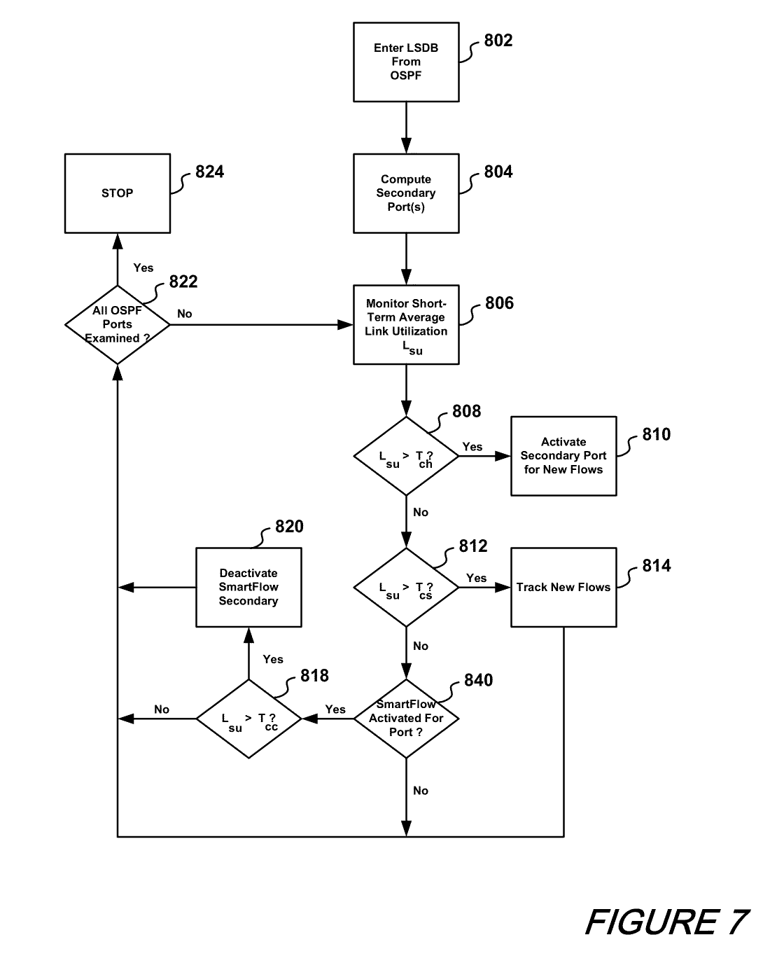

FIG. 7 shows an example flow chart of a method that illustrates how congestion avoidance may be implemented according to an aspect of the present disclosure. With initial reference to that figure, we begin by noting that T_{CS}, T_{CH} and T_{CC} are congestion thresholds indicating congestion levels when set, upon high congestion, and upon congestion clear states for a port. We note further that references to SmartFlow refer to those methods described previously. At block 702, a link state database (LSDB) is extracted from OSPF. As those skilled in the art will recall, the link state database is a database of all OSPF router LSAs, summary LSAs, and external route LSAs. The LSDB is compiled by an ongoing exchange of LSAs between neighboring routers so that each router is synchronized with its neighbor. To create the LSDB, each OSPF router must receive a valid LSA from each other router. This is performed through a procedure called flooding. Each router initially sends out an LSA which contains its own configuration. As it receives LSAs from other routers, it propagates those LSAs to its neighbor routers.

Continuing with our discussion of the figure, at block 704 for each OSPF network port on a router, a SmartFlow secondary port for every network address is determined. At block 706, at every t ms (milliseconds), for each OSPF network port on the router, short term average link utilization (Lₛᵤ) is monitored.

At block 708, a determination is made and if L_{SU}>T_{CH}, then secondary port for new flows is activated at block 710. If not, then a determination is made at block 712, and if L_{SU}>T_{CS}, then at block 714 new flows are tracked and the process continues to block 722.

Conversely, if L_{SU} is not >T_{CH}, then a determination is made at block 740 and if SmartFlow not activated for port then the process continues to block 722. Else if SmartFlow is activated then at block 718 a determination is made and if Lₛᵤ<T_{CC} then SmartFlow secondary are deactivated at block 720 and the process continues to block 722 else if L_{SU} is not >T_{CH}, the process continues to block 722.

At block 722 a determination is made whether all OSPF ports been examined and if so then the process stops at block 724 else the process continues at block 606.

### Proof of Loop-Free Routing

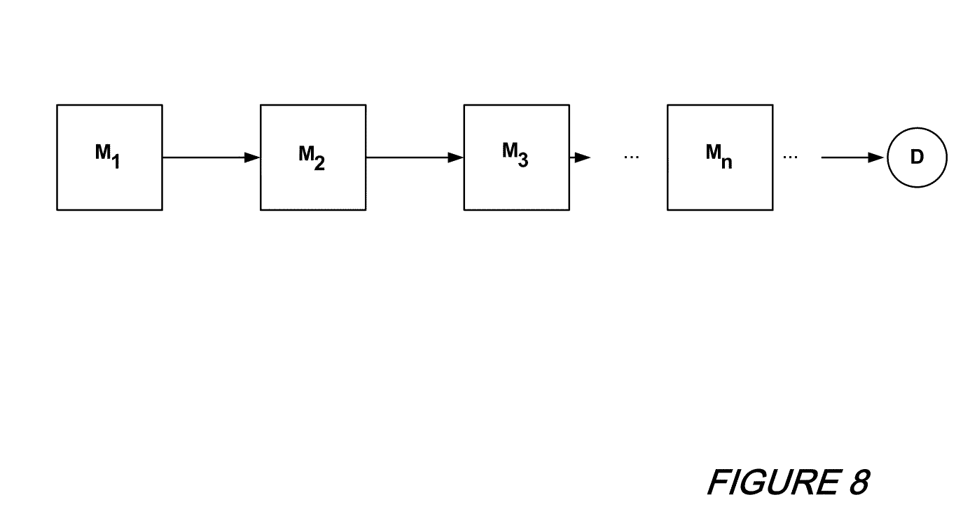

FIG. 8 shows a block diagram depicting a path constructed according to a method of the present disclosure from current router M₁ to destination server D. Such a path would be used—for example—if the primary link from each router M₁, M₂, M₃ . . . is congested.

M₂ is the neighbor router picked as the next hop router on the longer alternate path by the algorithm at current router M₁. Let C(i) denote the shortest path cost from router Mᵢ to server D. Then, from the algorithm construction rules, we know that C(M₂)≦C(M₁).

If C(M₂) is <C(M₁), then M₁ cannot be a candidate router on the longer alternate path for M₂ (since a candidate router must have shortest path cost no greater than the shortest path cost of the current router); also M₁ cannot be on the shortest path route from M₂ to D. For any subsequent router Mₙ on the path, C(Mₙ)≦C(M₂)<C(M₁), so C(Mₙ)<C(M₁), and M₁ can never be a candidate router for the longer path computation at Mₙ; for the same reason M₁ cannot be on the shortest path from Mₙ either. Therefore, if C(M₂)<C(M₁), the path can never return to M₁ and so cannot form a loop. Clearly, this is true at any intermediate router as well. For example, if Mₙ is the first router at which C(Mₙ)<C(M₁) and all prior routers had cost equal to C(M₁), then all routers after Mₙ will have cost less than C(M₁) and hence cannot be part of a loop. Thus, the only possible routers that can be involved in a loop must have cost equal to C(M₁).

Now consider the case where C(M₁)=C(M₂)= . . . C(Mₙ). The path M₁->M₂-> . . . ->Mₙ would result if the shortest path from each router M₁, M₂, . . . Mₙ₋₁, could not be taken because the corresponding link was congested, and, hence, the longer path was activated at each router. The algorithm picks the neighbor on the longer path by using the minimum node ID value. Suppose Mₙ is the first node from which a link exists to router M₁. Thus, Mₙ is also a neighbor of M₁ and potentially a loop M₁->M₂-> . . . ->Mₙ->M₁ can be formed. We will now show that such a loop is impossible if the minimum ID value rule is used.

Let the ID values of M₁, M₂, . . . Mₙ be i₁, i₂, . . . iₙ. Then, since M₁ picks M₂ over Mₙ as the neighbor router on its longer path, it follows that i₂<iₙ. Similarly, since M₂ picks M₃, we have i₃<i₁. Repeating this, we see that iₙ₋₁<iₙ₋₃ and iₙ<iₙ₋₂. Adding the left hand side and the right hand side of all these inequalities and cancelling out like terms, we see that iₙ₋₁<i₁. This implies that Mₙ must necessarily pick Mₙ₋₁ as the neighbor router on its longer path and thus the loop M₁->M₂-> . . . ->Mₙ->M₁ can never occur.

As mentioned earlier, a single-link loop will always occur, but the routers at the ends of the link can prevent packets from looping between the two routers.

### Alternative Metrics for Loop Prevention

Advantageously—and according to yet another aspect of the present disclosure—it is possible to use other link metrics for determining the next hop router on the longer path. Such a link metric must be independently computed by every router in a distributed manner based on locally available information. As an alternative let us consider using a link metric derived from the IDs of the routers at the two ends of the link. Suppose a link connects a router with ID value p to a router with ID value q, where p and q are positive integers.

Consider the link metric m(p,q), computed using the modified Cantor enumerator function (also known as the pairing function) as follows:

m(p,q)=½(p+q−2)*(p+q−1)+min(p,q) (1)

The traditional Cantor function [9], has two slightly different formulations

f(p,q)=½(p+q−2)*(p+q−1)+p (2)

g(p,q)=½(p+q−2)*(p+q−1)+q (3)

It is well known that both versions give unique values for each pair of positive integers (p,q). It, therefore, follows that the symmetric version of the Cantor function represented by equation (1) must also generate unique values for each pair of positive integers (p,q) except for the fact that because it is symmetric with respect to p and q, m(q,p)=m(p,q). The symmetry property is not critical to the operation of our invention but it is easier to see how loop prevention works when it is symmetric, hence, we will employ the symmetric Cantor function m(p,q) as the link metric. We can use any of the three metric definitions in equations (1), (2) and (3), we use the metric from (1) below, only for convenience.

The Cantor metric can also be chosen as some scaled version of the metric in equation (1), if desired (for example, one could multiply the Cantor metric by 100 to derive the link metric). This procedure applies to other routing protocols in an obvious way, since every routing protocol uses some router ID which may be used to derive an integer number associated with a given router for the purpose of computing the link metric.

Using this link metric, we may now modify the earlier described Step 2 as follows: Applying the metric m(p,q) in equation (1) to links RT D->RT E and RT D->RT F, we determine the link metric for RT D->RT E is m(10,7)=127, and the link metric for RT D->RT F is m(10,8)=144.

RT D picks the neighbor corresponding to the minimum value of the link metric m(p,q). Since m(p,q) generates a unique value for each distinct pair of integers p and q, it follows that there must exist a unique minimum link metric value among the links connecting RT D to its neighbors. In the present case, since m(10,7)<m(10,8), RT D picks RT E as the longer path neighbor to deload link RT D->RT B.

In order to show that the above procedure is guaranteed to avoid loops, consider FIG. 5. With reference now to that FIG. 5, there it shows the shortest path from each router to destination network 100.102.0.0, along with links interconnecting routers RT D, RT E and RT F (in dotted line). The link cost for each link in the shortest path to destination 100.102.0.0 is also shown. We saw that RT D picks RT E as the next hop neighbor on the longer path to 100.102.0.0. Applying Step 1 to RT E, it is clear that RT D and RT F are the candidate neighbors of RT E to serve as the next hop router on the longer path to deload link RT E->RT B for traffic to destination 100.102.0.0. Similarly, for RT F, applying Step 1 yields RT D and RT E as the candidate next hop routers on the longer path to deload link RT F->RT B for traffic to destination 100.102.0.0.

Applying Step 2 at RT E to its links to the candidate neighbors, it follows that link RT E->RT F has metric m(7,8)=98, and link RT E->RT D has metric m(7,10)=127 so RT F has the minimum link metric and RT E picks RT F as the next hop neighbor on its longer path to destination 100.102.0.0.

Applying Step 2 at RT F to its links to candidate neighbors RT E and RT D, it follows that link RT F->RT D has metric m(8,10)=m(10,8)=144, and link RT F->RT E has metric m(8,7)=m(7,8)=98 so RT F picks RT E as the next hop neighbor on its longer path to destination 100.102.0.0. Consequently, a loop consisting of RT D->RT E->RT F->RT D cannot be formed.

It is clear that picking the minimum value of m(p,q) at each router results in a hierarchy which avoids loops (this is a straight forward generalization of the example in FIG. 5, hence we omit the details). The algorithm, thus, guarantees loop freedom in all cases.

While this appears to be an alternative approach at first glance, it is easy to show that it is equivalent to the rule that picks the neighbor with the lowest ID value. It can be shown mathematically that if current router M₁ with ID value i has neighbor routers N with ID value j and Q with ID value k, then m(i,j)<m(i,k) if and only if j<k. This immediately implies that the two rules are exactly equivalent. Since comparing ID values is computationally more efficient than comparing the metric m(p,q), we prefer the former approach.

The mathematical proof of the equivalence of the two approaches is straightforward and is omitted for brevity. This equivalence also holds even if we use the Cantor functions from equations (2) or (3). Thus all these metrics are essentially equivalent from the perspective of finding loop-free alternate routes.

There may be other possible link metrics that a person conversant with the state-of-the-art may generate for preventing loop freedom. However, they are essentially equivalent to our approach and do not offer any substantially different mechanism for loop prevention or congestion avoidance.

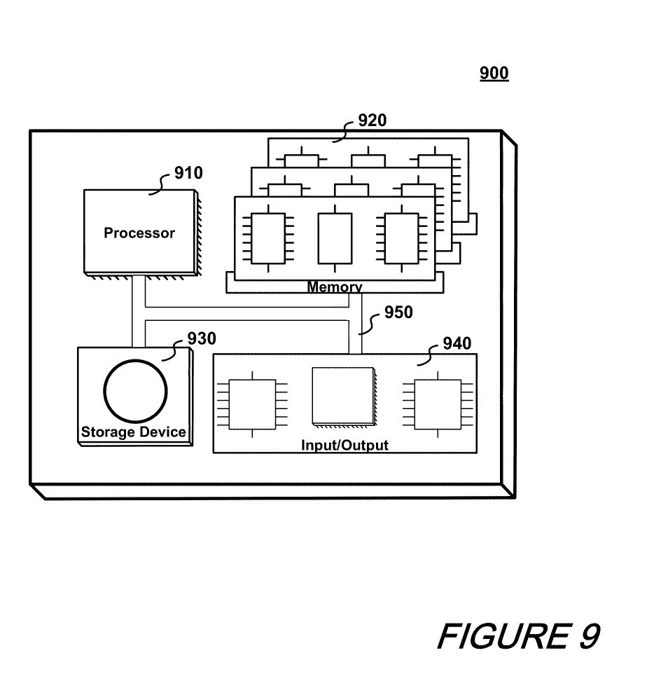

FIG. 9 shows an illustrative computer system 900 suitable for implementing methods and systems according to an aspect of the present disclosure. As may be immediately appreciated, such a computer system may be integrated into an another system such as a router and may be implemented via discrete elements or one or more integrated components. The computer system may comprise, for example a computer running any of a number of operating systems. The above-described methods of the present disclosure may be implemented on the computer system 900 as stored program control instructions.

Computer system 900 includes processor 910, memory 920, storage device 930, and input/output structure 940. One or more input/output devices may include a display 945. One or more busses 950 typically interconnect the components, 910, 920, 930, and 940. Processor 910 may be a single or multi core.

Processor 910 executes instructions in which embodiments of the present disclosure may comprise steps described in one or more of the Drawing figures. Such instructions may be stored in memory 920 or storage device 930. Data and/or information may be received and output using one or more input/output devices.

Memory 920 may store data and may be a computer-readable medium, such as volatile or non-volatile memory. Storage device 930 may provide storage for system 900 including for example, the previously described methods. In various aspects, storage device 930 may be a flash memory device, a disk drive, an optical disk device, or a tape device employing magnetic, optical, or other recording technologies.

Input/output structures 940 may provide input/output operations for system 900.

At this point, those skilled in the art will readily appreciate that while the methods, techniques and structures according to the present disclosure have been described with respect to particular implementations and/or embodiments, those skilled in the art will recognize that the disclosure is not so limited. Accordingly, the scope of the disclosure should only be limited by the claims appended hereto.

1. A method executing in a network element for improved shortest path first (SPF) routing, the method comprising the steps of:
extracting, a destination Internet Protocol (IP) network address from a routing table of the network element;
generating, a list of all neighbor network elements of the network element;
determining, a shortest path cost to the destination network address from the network element;
determining, a shortest path cost to the destination network address for each neighbor network element;
selecting, as a next hop network element, the neighbor network element having 1) a shortest path cost less than that of the network element and 2) is not on any Equal Cost Multi Path (ECMP) to the destination network address.

2. The method according to claim 1 further comprising selecting, as the next hop router, the neighbor network element having a particular unique ID assigned to the neighbor network element.

3. The method according to claim 2 wherein the unique ID assigned to the neighbor network element is one selected from the group consisting of: numerical OSPF ID value, management IP address, MAC address, unique ID assigned by a routing protocol.

4. The method according to claim 3 wherein the network elements are part of a Clos network having a plurality of spine nodes, a plurality of leaf nodes, and a plurality of server nodes, the method further comprising the steps of: adding an additional link between one or more nodes comprising the spine or leaf.

5. The method according to claim 3 further comprising sending a data packet addressed to the destination network to the next hop router for subsequent routing to the destination network.

6. The method according to claim 3 wherein the shortest path routing is one selected from the group consisting of: Open Shortest Path First (OSPF), Routing Information Protocol (RIP), Interior Gateway Routing Protocol (IGRP), Open Shortest Path First (OSPF), Intermediate System to Intermediate System (IS-IS), Ethernet networks Spanning Tree Protocol (STP), Transparent Interconnect of Lots of Links (TRILL), Border Gateway Protocol (BGP), 802.1.aq Shortest Path Bridging (SPB) including IEEE 802.1.aq.
